(19) United States
(12) Patent Application Publication
(10) Pub. No.: US 2024/0330272 A1
(43) Pub. Date: Oct. 3, 2024

(54) DECENTRALIZED GOVERNANCE OF SHARED INFRASTRUCTURE

(71) Applicant: VMware, Inc., Palo Alto, CA (US)

(72) Inventors: Michael W. Achenbach, Los Altos, CA (US); Vianney Rancurel, San Rafael, CA (US); Shruti Gandhi, San Jose, CA (US)

(21) Appl. No.: 18/194,259

(22) Filed: Mar. 31, 2023

(51) Int. Cl. G06F 16/23; G06F 21/60; G06F 21/62

(52) U.S. Cl. CPC G06F 16/2379; G06F 21/602; G06F 21/6218

(57) ABSTRACT

Various shared infrastructure governance decision-making systems and methods are disclosed. One such method comprises receiving, by at least one blockchain node from a client device, a reconfiguration request for changing infrastructure of a blockchain service by performing a reconfiguration action; triggering, by the at least one blockchain node, an infrastructure governance approval process to approve or deny the reconfiguration request for changing the infrastructure of the blockchain service; and invoking, by the at least one blockchain node, initiation of the reconfiguration action by the blockchain service upon approval of the reconfiguration request. Other methods and system are also disclosed.

### BACKGROUND

A Blockchain is a distributed, decentralized database or ledger that uses consensus algorithms and cryptographic signings to make a permanent and tamper resistant record of transactions. Blockchain platforms fall generally into two groups: (1) Permissionless or public blockchains and (2) Permissioned or private blockchains. While public blockchains impose no limits on who is allowed to join the blockchain, private blockchains limit the membership of the blockchain. As such, permissioned blockchains are well suited for interactions between organizations in a consortium environment, which tends to be smaller networks with nodes numbering in the tens to hundreds. Although the permissioned blockchain is private, the control remains decentralized and the infrastructure is shared with the organizations in the infrastructure and, in the most general case, the infrastructure is controlled by more than one entity. Thus, in a permissioned blockchain platform, nodes may be owned or operated by different entities who may not otherwise trust one another. Therefore, it is advantageous for a framework to be in place for facilitating a decision making process related to making changes or reconfiguring the permissioned blockchain infrastructure.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked computing environment for an enterprise using a permissioned blockchain in accordance with various embodiments of the present disclosure.

FIG. 2 is a schematic diagram illustrating a computer architecture of a blockchain service in accordance with various embodiments of the present disclosure.

FIG. 3 is a flowchart diagram depicting an exemplary infrastructure governance decision-making process in accordance with various embodiments of the present disclosure.

FIG. 4 is a flow or sequence diagram illustrating an execution of a process for requesting, approving, and invoking a reconfiguration action in accordance with various embodiments of the present disclosure.

FIG. 5 is a flow or sequence diagram illustrating an execution of a process for requesting, approving, invoking a reconfiguration action, and the provisioning of a status and a retry attempt for the reconfiguration action in accordance with various embodiments of the present disclosure.

FIG. 6 depicts a simplified block diagram of an example computer system according to certain embodiments.

### DETAILED DESCRIPTION

The present disclosure relates to decentralized governance of a shared infrastructure such as a permissioned blockchain. Accordingly, systems and methods of the present disclosure provide a framework to manage a shared infrastructure, where components of the infrastructure are owned by a number of independent parties in a limited trust environment and there is no central administrator. Thus, in accordance with the present disclosure, changes to the shared infrastructure are coordinated and performed in a decentralized and automated manner.

For example, a private distributed ledger or blockchain may be assembled by a consortium of independent organizations. As such, each organization can supply equipment and resources to establish the ledger. In this type of environment, a decentralized infrastructure governance decision process of the present disclosure can facilitate reconfiguration of the shared infrastructure, such as, but not limited to, adding or removing blockchain nodes and/or rotating/updating/revoking cryptographic keys, among other possible reconfiguration actions.

Previously, administration of blockchain systems has normally been authorized by Identity and Access Management (IAM) systems, such as Oauth2. Although these systems can be federated and have multiple centers of authority, they are not decentralized (where there are no centers of authority and collective authority is achieved through consensus). Forms of decentralized approval have also been used in Decentralized Autonomous Organizations (DAOs), where they have been used primarily to pool funds in the form of cryptocurrency and make decisions about the use of those funds (e.g., funding causes or purchasing items). However, such forms have not been used to control or make decisions about the blockchain infrastructure. Recently, due to malicious activity from inside organizations, companies, e.g. Amazon, have started implementing “threshold” schemes—for instance, for accessing customer data (e.g., three employees access keys are needed to decipher customer data). Even though this form of authentication/authorization can be seen as decentralized, it is only leveraging a cryptographic scheme and is not utilizing a decentralized shared infrastructure governance decision process (e.g., revoking cryptographic keys will go through a central decision process). Although Amazon offers Hyperledger Fabric as its permissioned blockchain framework, they do not innately support decentralized governance of their blockchain infrastructure. Instead, the Amazon managed blockchain provides APIs to configure voting rules for a blockchain network (hyperledger-fabric/Ethereum) which can be used by the network to add any AWS (Amazon Web Services) account to an existing blockchain network. While this voting mechanism can be seen as decentralized, its use-case is only limited to adding an AWS account and does not extend to controlling or making decisions concerning the blockchain infrastructure.

Accordingly, the present disclosure presents an exemplary shared infrastructure governance decision-making framework comprising a plurality of steps or stages approving a reconfiguration request via a consensus protocol and triggering automated execution of the reconfiguration of the blockchain infrastructure upon approval of the reconfiguration request. Thus, the combination of these steps/stages represents a novel process for managing blockchain infrastructure within a permissioned blockchain. Such operational steps of the decision-making processes are embedded in the blockchain network code, in accordance with various embodiments of the present disclosure.

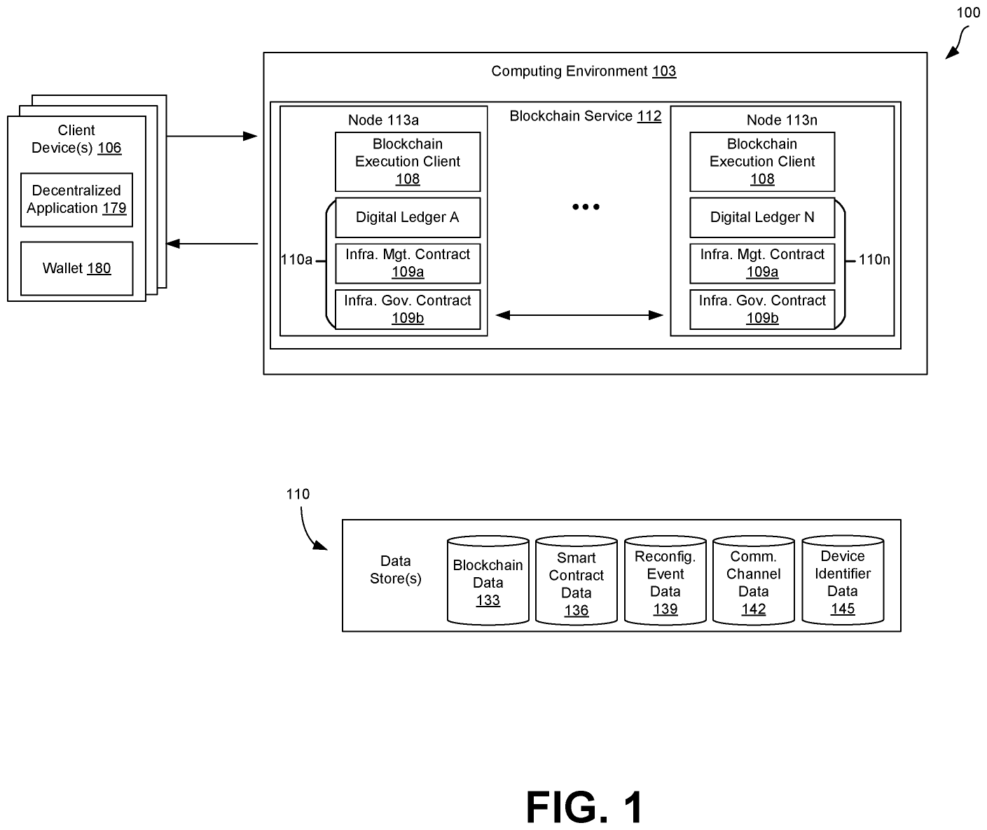

Turning now to FIG. 1, an example of a networked environment 100 is shown. The networked environment 100 can include client devices 106 and a computing environment 103 having a blockchain service 112 (via blockchain replica nodes 113a-113n that offers infrastructure management and governance smart contracts 109a, 109b stored in a replicated storage mediums 110a-110n across the blockchain nodes 113a-113n), in communication with one another over a network. The network can include, for example, the Internet, intranets, extranets, wide area networks (WANs), local area networks (LANs), wired networks, wireless networks, other suitable networks, or any combination of two or more such networks, including a blockchain network. In a blockchain network, the “blockchain” is represented in the network by storing a replica of the blockchain in each node 113 comprising the network. In FIG. 1, for example, each blockchain stored in each node 113 (“replica node”) is a replica of the blockchain maintained by blockchain network. Replica nodes 113 can be interconnected by a communication network for communication with every other node in the blockchain network. Each replica node 113 executes identical instructions (algorithms) that dictate how to update its shared ledger or blockchain with new transactions and how to determine whether those updates are valid. This configuration may be suitable in a private (permissioned) blockchain where the blockchain network can place restrictions on who is allowed to participate in the network and in what transactions.

The computing environment 103 can be formed of devices installed in racks, thereby forming a server bank, aggregate computing system, or a computer bank in a data center or other like facility. In some examples, the computing environment 103 can include one or more high-availability computing systems, which includes a group of computing devices that acts as a single system and provides a continuous uptime. The devices in the computing environment 103 can include any number of physical machines, virtual machines, virtual appliances, and software associated therewith, such as operating systems, drivers, hypervisors, scripts, smart contracts, wallets, user interfaces, decentralized applications (DApp), physical components (including hardware chips and circuitry), and other applications.

The computing environment 103, and the various hardware and software components contained therein, can include infrastructure of the networked environment 100 that provide one or more network application programming interfaces (APIs). For instance, the computing environment 103 can provide a network-based application programming interface that permits an application or service to generate, store, retrieve, delete, or otherwise interact with a decentralized application (DApp) 279 of the client device 106 and/or the blockchain service 112.

The computing environment 103 can include an enterprise computing environment that includes hundreds or even thousands of physical machines, virtual machines, and other software implemented in devices stored in racks, distributed geographically, and connected to one another through the network. As such, the computing environment 103 can be referred to as a distributed computing environment in some examples.

It is understood that any virtual machine or virtual appliance is implemented using at least one physical device, such as a server or other computing device. The physical computing resources of the computing environment 103 can include, for example, physical computing hardware, such as memory and storage devices, servers, switches, graphics cards having one or more GPUs installed thereon, central processing units (CPUs), power supplies, and similar devices. In various examples, the computing environment 103 can include requisite physical hardware and software to create and manage virtualization infrastructure, a cloud computing environment, an on-premises environment, and/or a serverless computing environment.

Each server can act as a host in the computing environment 103, and thereby can include one or more virtual machines (VMs). In some examples, a hypervisor can be installed on a server to support a virtual machine execution space within which one or more virtual machines can be concurrently instantiated and executed. The hypervisor can include the ESX™ hypervisor by VMware®, the ESXi™ hypervisor by VMware®, or similar hypervisor. It is understood that the computing environment 103 can be scalable, meaning that computing resources of the computing environment 103 can increase or decrease dynamically to include or remove servers, switches, GPUs, power sources, and other components without downtime or otherwise impairing performance of the services offered by the computing environment 103.

The computing environment 103 can include one or more computing devices that are arranged, for example, in one or more server banks, computer banks, computing clusters, or other arrangements. The computing environment 103 can include a grid computing resource or any other distributed computing arrangement. The computing devices can be located in a single installation or can be distributed among many different geographical locations. The computing environment 103 can include or be operated as one or more virtualized computer instances in some examples.

For purposes of convenience, the computing environment 103 is referred to herein in the singular. Even though the computing environment 103 is referred to in the singular, it is understood that a plurality of computing environments 103 comprising a plurality of blockchain nodes 113 can be employed in the various arrangements as described above. As the computing environment 103 communicates with the client devices 106 over the network, sometimes remotely, the computing environment 103 can be described as a remote computing environment 103 in some examples.

Accordingly, in various embodiments, a client device 106 can include a DApp 179 and a wallet application 180 or other type of client application to initiate blockchain transaction requests and interface with a blockchain execution client 108 (e.g., Ethereum client), where the blockchain execution client 108 requests for the blockchain service (e.g., Ethereum virtual machine processes) to be implemented on the node device and in the process can receive incoming client requests and place transaction on the blockchain. Hence, the blockchain service 112 is deployed on the plurality of blockchain processing devices or nodes 113 that collectively implement one or more smart contract programs of the blockchain service that are contained in blocks of the blockchain. Accordingly, in various embodiments, the blockchain service 112 can comprise the blockchain execution client 108 that handles and dispatches the incoming blockchain requests, such as those related to requesting data, executing functions, returning a response, or transmitting data, and places transactions on the blockchain via remote procedure calls. In various embodiments, the blockchain execution client 108 is configured to trigger internal maintenance or housekeeping tasks and may dispatch maintenance or reconfiguration calls made by other blockchain nodes or services, including the infrastructure management and governance smart contracts 109a, 109b.

The blockchain nodes 113a-113n of the computing environment 103 can include a data store 110 which can include one or more databases in some examples. The data store 110 can include memory, mass storage resources, or any other storage resources on which data can be stored. The data store 110 can include memory of one or more servers in some examples. Further, the data store 110 can include one or more relational databases, such as structured query language databases, non-SQL databases, or other relational or non-relational databases. The data stored in the data store 110, for example, can be associated with the operation of the various services or functional entities described below. In various embodiments, each of the blockchain nodes 113 maintains a replica of contents of the data store.

In various embodiments, the blockchain service 112 includes a network service that implements a blockchain protocol on a plurality of computing nodes, which may include servers maintaining one or more infrastructure management and governance services contracts 109. Accordingly, the blockchain service 112 may include tamper resistant digital ledgers implemented in a distributed computing arrangement without a central repository.

The data store 110 can also include blockchain data 133, smart contract data 136, reconfiguration event data 139, communication channel data 142, device identifier data 145, as well as other data. Blockchain data 133 can include data associated with one or more “blocks,” which are data objects stored in the blockchain service 112. Smart contract data 136 can include information associated with a smart contract protocol, which can include a data object utilized by various types of blockchain services 112. For instance, the smart contract data 136 can include criteria for approving a reconfiguration request, criteria for triggering a reconfiguration action, criteria for updating a status of a pending reconfiguration request, etc., where the reconfiguration action is generally an operation that reconfigures the underlying blockchain (e.g. cryptographic key-exchange, pruning, software upgrade, adding/removing nodes, etc.) and a reconfiguration status generally specifies whether the reconfiguration action has successfully completed or not and may specify a reason for a failure, if applicable). Additionally, the smart contract can include code for validating data of the blockchain service 112, code that directs a computing device to validate the data, as well as other data. In this case, an exemplary decentralized shared infrastructure governance decision-making process of the present disclosure can facilitate approval of a reconfiguration request and authorize a reconfiguration action on the system, including calling smart contracts or related services for performing operational steps of the shared infrastructure governance decision-making process.

Reconfiguration event data 139 can include information associated with one or more reconfiguration requests, such as status updates on pending reconfiguration requests. Communication channel data 142 can include information associated with one or more communications channels utilized by blockchain service 112. For instance, communication channel data 142 can include a list of DApps 179 or other nodes that subscribe to particular types of events, such as reconfiguration or reconfiguration-related events. Device identifier data 145 can include identifiers that uniquely identify a client device 106. In some examples, a unique identifier includes an alphanumeric string that can be used to query the data store 110 or blocks in the blockchain service 112 to identify reconfiguration event data 139 associated with a corresponding DApp 179 or client device 106.

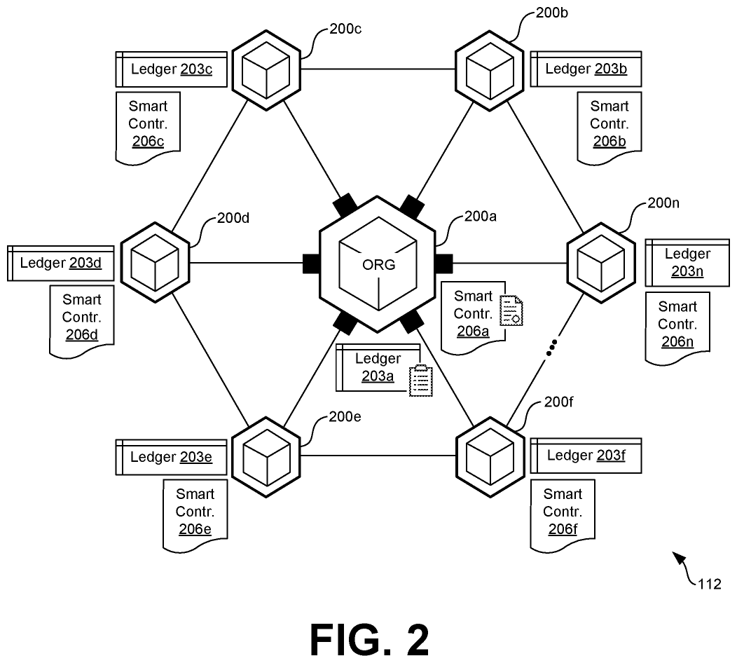

Referring now to FIG. 2, a schematic diagram of the blockchain service 112 is shown according to various examples. In some examples, the blockchain service 112 includes a permission-based blockchain deployed by a collective or organization of respective entities (“ORG”), which can include an enterprise in some examples. As can be appreciated, the blockchain service 112 is a blockchain protocol implemented by a plurality of computing nodes 200a-200n (e.g., 113a-113n). The computing nodes 200 can include a server or collection of servers maintained by the organization or collective of respective entities. For instance, the computing environment 103 can include a first one of the nodes 200a and other servers owned by various entities can include other ones of the nodes 200b-200n. Further, each of the nodes 200 can include smart contracts 206a-206n (or “smart contract protocols”) that are present at every node 200.

Smart contracts 206 can include programs or data objects having executable code that is executed to direct a respective node 200 to perform infrastructure management and governance tasks and other tasks described herein. Generally, execution of a smart contract 206 implements a prescribed interface. As such, operational logic of the blockchain service 112 can reside in the smart contract 206. In various examples, the smart contract 206 initializes and manages a state of the digital ledger 203 (e.g., 203a . . . 203n) through transactions submitted by the nodes 200, including reconfiguration requests submitted to an infrastructure management protocol or smart contract 109a via a DApp 179.

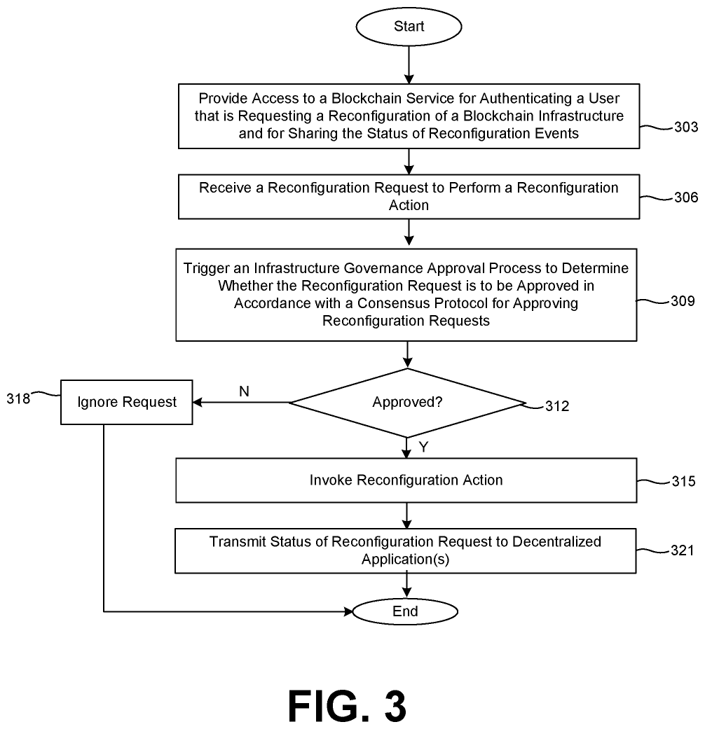

Moving on to FIG. 3, a flowchart is shown that provides one example of task of a portion of the networked environment 100 involving the exemplary shared infrastructure governance decision-making process. The flowchart of FIG. 3 can be viewed as depicting an example of elements of a method implemented by an infrastructure management contract executed by a node 113, 200 of the blockchain service 112 according to one or more examples of the present disclosure. The separation or segmentation of functionality as discussed herein is presented for illustrative purposes only.

Beginning with step 303, the computing environment 103 can provide access to a blockchain service 112 for authenticating a user that is requesting a reconfiguration of a blockchain infrastructure and for sharing the status of reconfiguration events. For instance, in an illustrative example, prior to submitting a reconfiguration or infrastructure change request, a user is identified to the blockchain service 112. To do so, a decentralized application (DApp) 179 of the user (e.g., a user with administrative privileges) maintains a private key that is stored by the wallet 180 and is inaccessible to external processes. The user also has public information (e.g., account number and a public key) that is maintained by the wallet 180 and is also accessible to external processes. Thus, in accordance with various embodiments, a reconfiguration request can include a transaction signature of the wallet 180 comprising an encryption of the account number using the private key of the user, such that the user can be verified by a target node on the blockchain by using the public key of the user to decode the transaction signature and comparing it with the user's account number. Accordingly, the private and/or public keys of blockchain nodes 113 and client devices 106 can be stored in a key infrastructure management system of the blockchain network, in various embodiments.

In step 306, the authenticated user can make a reconfiguration request to perform a reconfiguration action that is received by the computing environment 103, where the reconfiguration action is generally an operation that reconfigures the underlying blockchain, such as a cryptographic key-exchange action, a pruning action, a software upgrade action, an action for adding/removing nodes, etc. To submit the reconfiguration request, the user can interact with a web user interface of the DApp 179. For example, in various embodiments, the web user interface is provided by the DApp 179 that offers access to an shared infrastructure management service, such as an infrastructure management smart contract 109a (“infrastructure management contract”) deployed on nodes 113 of the blockchain network. Accordingly, a reconfiguration request can be generated using the web user interface, such that the reconfiguration request is transmitted to the infrastructure management smart contact. Parameters associated with the request can include a request identifier, type of the request, name of the target, expiration time, user identifier that submitted the request, etc.). In various embodiments, the parameters can be memorialized or documented in the infrastructure management contract 109a or in a log or as an event (e.g., Ethereum emit event) of the blockchain network, such that any sensitive parameter can be encrypted with a public key of the smart contract (e.g. if they appear in a block accessible by all members of the permissioned blockchain).

In step 309, the infrastructure management contract 109a receives the reconfiguration request from the client device 106 of the user and triggers a shared infrastructure governance approval process to determine whether the reconfiguration request is to be approved or denied in accordance with a consensus protocol for approving reconfiguration requests. In general, multiple user (associated with specific account numbers or identifiers) within the blockchain network can be authorized to participate in the consensus protocol for approving reconfiguration requests, with one or more “approver” nodes being operated by a respective entity. In various embodiments, the infrastructure management contract 109a maintains a list of users (approvers) that are authorized to vote on the reconfiguration request. Thus, in various embodiments, the infrastructure management contract 109a can be configured to determine or call another smart contract (e.g. infrastructure governance contract 109b) that can determine whether a consensus is reached among a plurality of approvers, wherein the respective smart contract uses the private key of the respective management contract to digitally sign a message requesting a vote on whether to approve or reject the reconfiguration request, and sends the digitally signed message to the nodes of the plurality of approvers, wherein the public key of the respective smart contract enables the approver nodes to validate the message sent from the contract.

In accordance with the present disclosure, smart contracts, such as the infrastructure management contract 109a, can implement a process that includes several stages or steps. In this example, one stage includes a request for approval of a reconfiguration request. Thus, the infrastructure management contract 109a may call another smart contract, such as the infrastructure governance contract 109b, to perform certain operations and may pass data to the infrastructure governance contract 109b that is needed to be processed in order to determine consensus of the reconfiguration request. Using the provided data, the infrastructure governance contract 109b can communicate with the approver nodes, collect the votes from the approvers, and determine whether a consensus is reached according to consensus rules specified or defined in the infrastructure governance contract 109b, such that the consensus rules represent a process logic for processing the results of the voting by the approvers. The result of the determination of whether an approval is reached may then be returned to the infrastructure management contract 109a.

Correspondingly, in steps 312 and 315, if the reconfiguration request is approved, the infrastructure management contract 109a can trigger the invocation of the reconfiguration action by the blockchain service 112 given certain constraints, such as those memorialized in the infrastructure management contract 109a (e.g. request parameters including request identifier, type of the request, name of the target, expiration time, etc.). Otherwise, in steps 312 and 318, if the reconfiguration request is not approved, no reconfiguration action is needed to be performed by the blockchain network and the request can be ignored. Lastly, in step 321 the infrastructure management contract 109a can transmit a status of the reconfiguration request to a decentralized application (DApp) 179 of the user that submitted the request and/or to the decentralized applications (DApps) of the approvers that voted on the DApp.

In accordance with the present disclosure, a plurality of types of reconfiguration actions or services can be triggered by or called by the infrastructure management contract 109a with respect to shared blockchain infrastructures. As non-limiting examples, one such reconfiguration action includes authorizing and/or revoking access to certain resources of the blockchain. With this type of action, the infrastructure management contract 109a can trigger the granting or revoking of access of a user or an organization from being able to perform an action on the blockchain, including calling certain smart contracts.

Another exemplary reconfiguration action involves rotating node cryptographic keys. Here, an administrator user may ask for his or her client device 106 to change cryptographic keys (e.g., following a security attack) and may submit a reconfiguration request to rotate the keys. Once authorized (voted), the key rotation process is invoked or called by the infrastructure management smart contract 109a to the blockchain service 112.

Another exemplary reconfiguration action involves adding or removing a node from the blockchain network. For example, an administrator (user) may want to add a node to the blockchain network. To do so, the administrator can submit a reconfiguration request asking for permission to add the node. Once authorized (voted), the node can be added as a blockchain participant by the blockchain service 112 (e.g., the infrastructure management contract 109a can request the blockchain execution client 108 to make the requisite procedure call(s) to the blockchain service 112) to trigger performance of the reconfiguration action.

Next, another possible reconfiguration action, among others, is upgrading of smart contract(s). For example, as the functionality provided by smart contracts becomes obsolete with time, or end-user requirements served by the smart contract change, a node 113 of an organization may request to upgrade a smart contract. Once authorized (voted), upgrading of the smart contract can be invoked by the infrastructure management contract 109a through the blockchain execution client 108.

Similarly, another possible reconfiguration action is upgrading node software. In this case, an administrator (user) may want to upgrade a node's software (e.g., to incorporate bug fixes, add security patches or features, etc.). Thus, the administrator can request for permission to upgrade a node's software, and once authorized (voted), the infrastructure management contract 109a can trigger the upgrade process to take place through interactions with the blockchain execution client 108.

Further, an organization may also want to periodically backup a blockchain node's data store 110a-110n and/or restore data (e.g., for disaster recovery) to the node's data store 110a-110n. In this case, an exemplary reconfiguration action can be to perform a backup and restore action, where an administrator (user) can submit a reconfiguration request to backup data on a particular blockchain node. Once authorized (voted), the infrastructure management contract 109a can invoke the blockchain service to backup data in the node's data store 110a-110n. Similarly, to restore the data after a disaster, the administrator can submit a reconfiguration request to restore data to a particular blockchain node or database, such that data is restored upon authorization (voting) and invocation of the action by the infrastructure management contract 109a.

In accordance with the present disclosure, the shared infrastructure governance decision-making process is highly configurable, based on the needs of a particular consortium, e.g. a given user can be simply identified by its account number (e.g., Ethereum account number) or can appear in a smart contract (e.g., Ethereum smart contract) as a member of an organization where it has been previously registered. This framework allows the implementation of a number of different approval schemes, including, but not limited, to coin-based voting, such as those used in several Decentralized Autonomous Organizations (DAOs), proxy voting, organizational and individual approval, Multi Party Computation (MPC) approval, such as multi-sig wallets, customized workflows, etc. A record indicating that the approver entities reached consensus may also be recorded in the blockchain, such as by the blockchain execution client 108. Therefore, when electronic voting using a smart contract is deployed on the blockchain, various advantages may be obtained, including transparency and the possibility of later disputes being avoided.

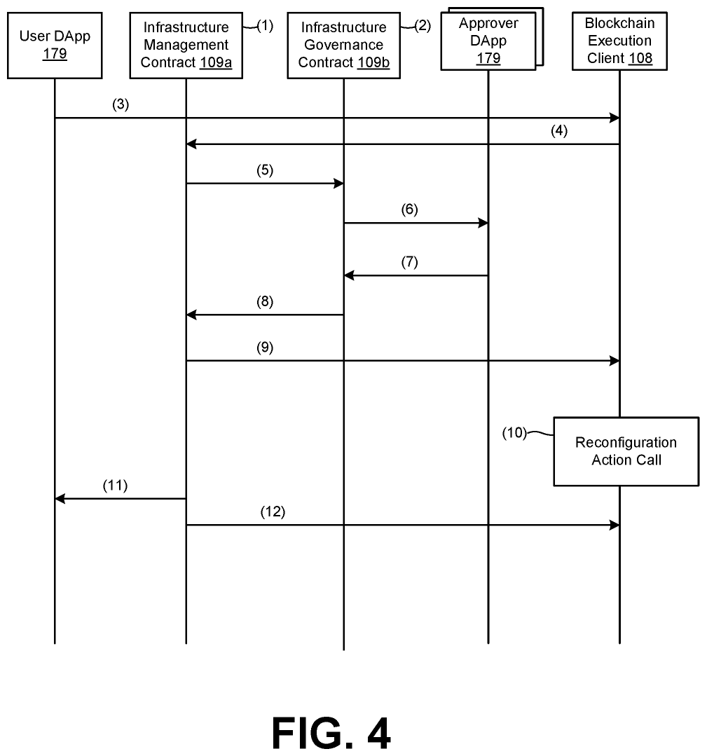

Referring now to FIG. 4, a flow or sequence diagram is provided that illustrates an execution of a process for requesting, approving, and invoking a reconfiguration action involving updating of cryptographic keys within a blockchain service 112. In one exemplary embodiment, the execution of the process is performed by bytecode assembly extension (e.g., Ethereum assembly calls). As shown in the diagram, an infrastructure management contract 109a and a governance contract 109b are first deployed within a blockchain service 112, as indicated by sequence number 1 and 2. Next, a user makes a reconfiguration request via a web-based user interface form provided by a DApp 179. In this example, the request involves a request to perform a key exchange that is to be directed to the infrastructure management contract 109a in order to seek approval for the key exchange within the shared blockchain infrastructure. In various embodiments, before sending the request, the user wallet 180 is configured to sign the transaction request and the DApp 179 sends (3) the signed transaction request to the blockchain execution client 108 which directs (4) the request to the infrastructure management contract 109a. In accordance with various embodiments, the infrastructure management contract 109a is configured to call (5) an infrastructure governance contract 109b (to approve or deny the reconfiguration request) and pass the request identifier & request parameters to the infrastructure governance contract 109b for consideration by authorized entities (approvers) for voting on the reconfiguration request. Accordingly, in various embodiments, the infrastructure governance contract 109b emits (6) an event that is received by the approvers of the reconfiguration request. For example, a user interface to a DApp 179 of an approver entity may receive notification when events are emitted by the infrastructure governance contract 109b via an subscription (e.g., eth_subscription). Thus, the event may notify the user interface of the DApp 179 of the respective approver entity, such that a list of pending approvals may be displayed by the DApp user interface. Alternatively, the user interface could poll the infrastructure governance contract 109b for pending approvals. In one embodiment, for an approval of the reconfiguration request, a quorum of approvers send (7) votes approving the key exchange request to the infrastructure governance contract 109b, which returns (8) an approval of the request to the infrastructure management contract 109a. Accordingly, a record indicating that the approver entities reached consensus may also be recorded in the blockchain. The infrastructure management contract 109a may then trigger (9) a transaction authorizing the requested reconfiguration action, i.e. the key exchange action, to be performed by the blockchain service 112 (e.g. the blockchain execution client 108 makes a call to perform (10) the key exchange action). In various embodiments, the infrastructure management contract 109(b) can emit (11, 12) an approval event to the DApp 179 of the user and/or the approver(s).

Accordingly, given that there may be cases where a reconfiguration action may fail after being triggered by the infrastructure management contract 109a, an exemplary infrastructure management contract 109a may include operational steps or stages for providing the status of the reconfiguration action to the user that initially submitted the request and/or for automatically retrying or reinitiating a failed reconfiguration action. For example, in various embodiments, the capability is provided for a user to obtain the status of a reconfiguration action (such as key exchange, pruning, etc.). Additionally, in various embodiments, the capability is provided for a user to specify parameter(s) for automated retries of a reconfiguration action, such as a ‘number of retries’ and a ‘timeout period’ for a decentralized managed reconfiguration action. Thus, in various embodiments, reconfiguration actions can have a mechanism for automated retries based on an end-operator or user set configuration parameters.

Thus, after any reconfiguration action is triggered, user(s) can use the status action to get its real-time status, such as specifying whether the decentralized managed action has successfully completed or not, along with the number of retry attempts made. In various embodiments, the status information can be collected at the DApp 179 of the user(s), such that user can observe the status from all replica instances that performed the reconfiguration action. In case of unsuccessful completion of the triggered action, the retriggering of the reconfiguration action can be automated such that the responsibility is not on the end-operator(s) or user(s) to manually monitor and request for a retriggering of the reconfiguration action.

Further, in accordance with various embodiments, a retry attempt (to perform a reconfiguration action) does not need to be re-approved, since the initial approval via voting was collected when the action was first triggered and thus is valid for subsequent retry attempts associated with the action. In accordance with various embodiments, the retry process is handled at the contract level. Therefore, no external clients are used to trigger a retry reconfiguration action, and the retry reconfiguration requests are sent for execution via the internal blockchain execution client 108. Accordingly, retry attempts are handled in the same way as the initial reconfiguration request action, where the blockchain execution client 108 is called by the infrastructure management contract to invoke the reconfiguration action. However, a subsequent manual retry triggered after repeated failures for a maximum ‘number of retries’ attempts is to be treated as a new reconfiguration request and will be required to go through the voting approval process.

In various embodiments, the blockchain execution client 108 dispatches a request to blockchain nodes 113a-113n to record the reconfiguration actions that have been invoked in their replicated storage mediums 110a-110n (e.g., reserved memory page of a data store) and to update its current status when the state changes for a progress of the reconfiguration action (e.g., in-progress/completed/failed). Therefore, the status of the reconfiguration action is available for other nodes of the blockchain service 112. Alternatively, the blockchain execution client 108 can transmit status information to the infrastructure management contract 109a.

In various embodiments, in order to determine when a retry attempt should be commenced, a timer is started at initiation of the reconfiguration action or at a time that a call is made for the reconfiguration action to be performed by the blockchain service 112. Accordingly, at expiration of a set timeout value for the timer, the status of the reconfiguration action is indicated to be ‘failed’ and is recorded in the replicated storage medium by the blockchain execution client 108. And, the blockchain execution client 108 reinvokes the reconfiguration action as long as the limit on the number of retries (set by the user) has not been met.

Additionally, in various embodiments, replica nodes 113a-113n of the blockchain service 112 each generate a reconfiguration action status upon invocation of a reconfiguration action using the blockchain execution client 108. Thus, a decentralized reconfiguration action status can be composed of the reconfiguration statuses from all the replica nodes via status aggregation. In various embodiments, one of the replica nodes 113a is selected to aggregate all of the status replies and return the aggregated status reply to the infrastructure management contract 109a or records them in a replicated storage medium that is accessible to the infrastructure management contract 109a. In turn, the infrastructure management contract 109a can emit the returned aggregated status reply as an event, which can then be monitored or polled by the DApp 179 of the user that submitted the reconfiguration request initially or by the DApp 179 of an approver entity that voted on the reconfiguration request. Alternatively, in various embodiments, each replica node 113 that invoked the reconfiguration action can emit an event with the reconfiguration status (provided from its blockchain execution client application 108 and recorded on a replicated storage medium 110a-110n of a data store). In this instance, the DApp 179 of the user or approver can monitor or poll the reconfiguration statuses provided from all of the replica nodes and can display the status responses as it receives them or can aggregate the received responses to determine an overall status of the reconfiguration action.

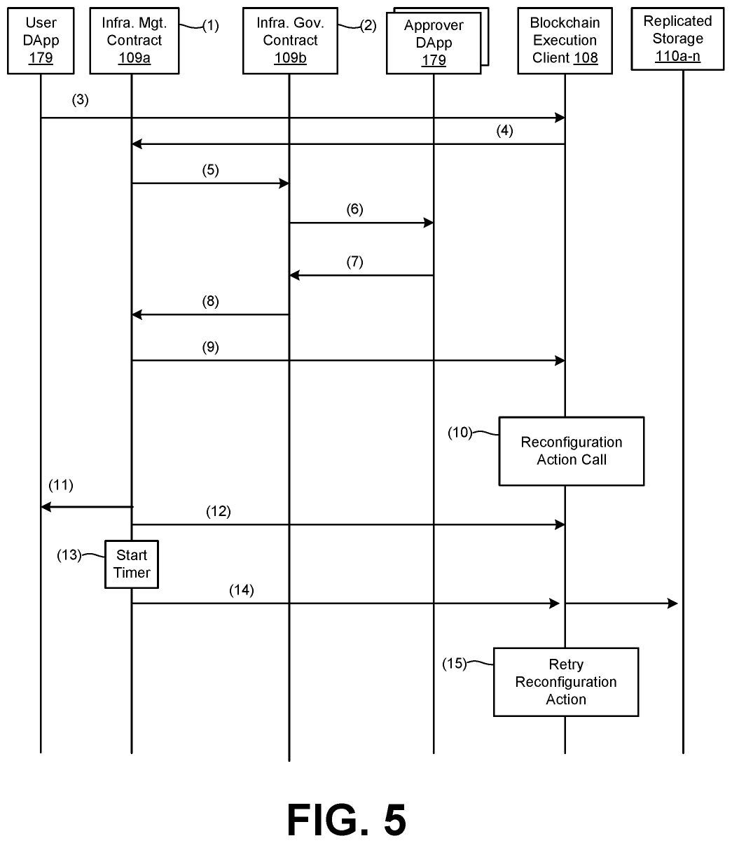

Referring now to FIG. 5, a flow or sequence diagram is provided that illustrates an execution of a process for requesting, approving, invoking a reconfiguration action involving updating of cryptographic keys within a blockchain service 112, and the provisioning of a status and a retry attempt for the reconfiguration action. First, an infrastructure management contract 109a and an infrastructure governance contract 109b are deployed (1, 2) on the blockchain network. Next, a user makes a reconfiguration request via a web-based user interface form provided by a DApp 179. In this example, the request involves a request to perform a key exchange that is directed to the infrastructure management contract 109a in order to in order to seek approval for the key exchange within the shared or permissioned blockchain infrastructure. In various embodiments, before sending the request, the wallet application 180 is configured to sign the transaction request and the DApp 179 sends (3) the signed transaction request to the blockchain execution client 108 which directs (4) the request to the infrastructure management contract 109a. In accordance with various embodiments, the infrastructure management contract 109a is configured to call (5) an infrastructure governance contract 109b (to approve or deny the reconfiguration request) and pass the request identifier & request parameters to the infrastructure governance contract 109b for consideration by authorized entities (approvers) for voting on the reconfiguration request. Accordingly, in various embodiments, the infrastructure governance contract 109b emits (6) an event that is received by the approvers of the reconfiguration request. For example, a user interface to a DApp 179 of an approver entity may receive notification when events are emitted by the infrastructure governance contract 109b via an subscription (e.g., eth_subscription). Thus, the event may notify the user interface of the DApp 179 of the respective approver entity, such that a list of pending approvals may be displayed by the DApp user interface. Alternatively, the user interface could poll the infrastructure governance contract 109b for pending approvals. In one embodiment, for an approval of the reconfiguration request, a quorum of approvers send (7) votes approving the key exchange request to the infrastructure governance contract 109b, which returns (8) an approval of the request to the infrastructure management contract 109a. Accordingly, a record indicating that the approver entities reached consensus may also be recorded in the blockchain. The infrastructure management contract 109a may then trigger (9) a transaction authorizing the key exchange action to be performed by the blockchain (e.g. the blockchain execution client 108 makes a call to perform (10) the key exchange action). In various embodiments, the infrastructure management contract 109(b) can emit (11, 12) an approval event to the DApp 179 of the user and/or the approver(s). Additionally, the infrastructure management contract 109a can be configured to initiate (13) a timer at initiation of the reconfiguration action (key exchange execution) in order to determine when a retry attempt should possibly be commenced. Further, in various embodiments, the infrastructure management contract 109a and the blockchain execution client 108 are configured to persist (14) the reconfiguration action and its default status (in-progress) in a replicated storage medium of the blockchain nodes (e.g., reserved pages) at initiation of the timer. Then, upon completion of the reconfiguration action (key-exchange), its final status will also be updated in the replicated storage medium. In the meantime, however, if a set timeout value for the timer expires (before completion of the reconfiguration action) and the status fetched from the replicated storage medium indicates that that the execution of the reconfiguration action was still on-going and not completed or final, then a status of the reconfiguration action will be updated to ‘failed’ and the reconfiguration action will be retried (15) as long as a number of retry attempts for the reconfiguration action has not exceed a set limit (as recorded in the infrastructure management contract 109a). Thus, steps or sequences 13-15 can be repeated until the set limit is exceeded if each attempt results in a failure. Accordingly, a retry attempt will be allowed to be performed when the maximum limit has not been exceeded and will be prohibited when the maximum limit has been exceeded, in various embodiments.

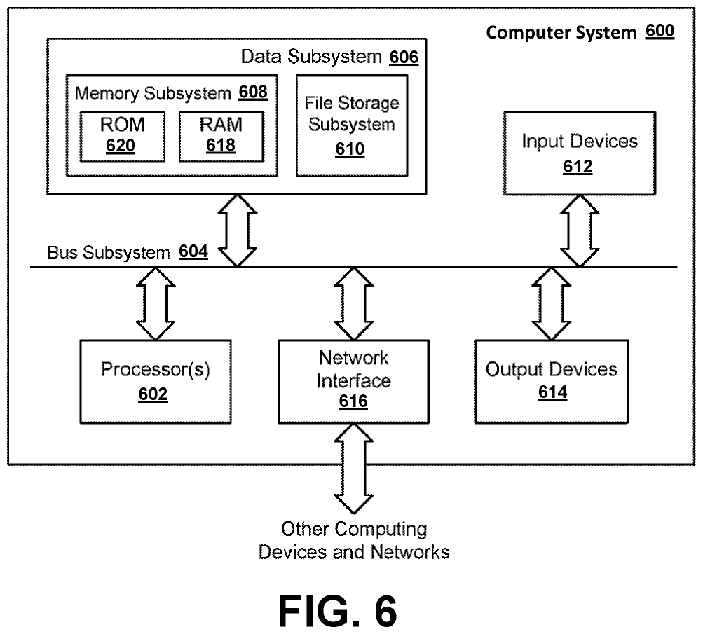

Referring now to FIG. 6, a simplified block diagram of an example computer system 600 is depicted according to certain embodiments. Computer system 600 can be used to implement nodes in the blockchain network described in the present disclosure. As shown in FIG. 6, computer system 600 includes one or more processors 602 that communicate with a number of peripheral devices via a data bus subsystem or interface 604. These peripheral devices include data subsystem 606 (comprising memory subsystem 608 and file storage subsystem 610), user interface input devices 612, user interface output devices 614, and network interface subsystem 616.

Bus subsystem 604 can provide a mechanism that enables the various components and subsystems of computer system 600 to communicate with each other as intended. Although bus subsystem 604 is shown schematically as a single bus, alternative embodiments of the bus subsystem can utilize multiple busses.

Network interface subsystem 616 can serve as an interface for communicating data between computer system 600 and other computer systems or networks; e.g., other nodes in the blockchain network. Embodiments of network interface subsystem 616 can include, e.g., an Ethernet card, a Wi-Fi and/or cellular adapter, digital subscriber line (DSL) units, and/or the like.

User interface input devices 612 can include a keyboard, pointing devices (e.g., mouse, trackball, touchpad, etc.), a touchscreen incorporated into a display, audio input devices (e.g., voice recognition systems, microphones, etc.) and other types of input devices. In general, use of the term “input device” is intended to include all possible types of devices and mechanisms for inputting information into computer system 600.

User interface output devices 614 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 600.

Data subsystem 606 includes memory subsystem 608 and file/disk storage subsystem 610 represent non-transitory computer-readable storage media that can store program code and/or data, which when executed by processor 602, can cause processor 602 to perform operations in accordance with embodiments of the present disclosure.

Memory subsystem 608 includes a number of memories including main random access memory (RAM) 618 for storage of instructions and data during program execution and read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art. Memory can include both volatile and nonvolatile memory and data storage components.

In addition, a processor can represent multiple processors and/or multiple processor cores, and the one or more memory devices can represent multiple memories that operate in parallel processing circuits, respectively. In such a case, a local interface can be an appropriate network that facilitates communication between any two of the multiple processors or between any processor and any of the memory devices. The local interface can include additional systems designed to coordinate this communication, including, for example, performing load balancing. The processor can be electric or of some other available construction.

It should be appreciated that computer system 600 is illustrative and many other configurations having more or fewer components than system 600 are possible. These and other variations, modifications, additions, and improvements may fall within the scope of the appended claims(s). As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Client devices 106 can be used to access user interfaces generated to configure or otherwise interact with the computing environment 103. These client devices 106 can include a display upon which a user interface generated by a client application for providing a virtual desktop session (or other session) can be rendered. In some examples, the user interface can be generated using user interface data provided by the computing environment 103. The client device 106 can also include one or more input/output devices that can include, for example, a capacitive touchscreen or other type of touch input device, fingerprint reader, or keyboard.

The sequence diagrams and flowcharts show an example of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram and flowcharts show a specific order of execution, it is understood that the order of execution can differ from that which is depicted. For example, the order of execution of two or more blocks can be scrambled relative to the order shown. In addition, two or more blocks shown in succession can be executed concurrently or with partial concurrence. Further, in some examples, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including program code, instructions, and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described examples of the present disclosure are merely possible examples of implementations set forth for a clear understanding of the principles of the disclosure. Many variations and modifications can be made to the above-described embodiments without departing substantially from the principles of the disclosure. All such modifications and variations are intended to be included herein within the scope of this disclosure.

Therefore, the following is claimed:

1. A infrastructure governance decision-making method comprising:
receiving, by at least one blockchain node from a client device, a reconfiguration request for changing infrastructure of a blockchain service by performing a reconfiguration action;
triggering, by the at least one blockchain node, an infrastructure governance approval process to approve or deny the reconfiguration request for changing the infrastructure of the blockchain service; and
invoking, by the at least one blockchain node, initiation of the reconfiguration action by the blockchain service upon approval of the reconfiguration request.

2. The method of claim 1, wherein the reconfiguration action comprises a cryptographic key-exchange action, a pruning action, a software upgrade action, or an action to add or remove one or more blockchain nodes.

3. The method of claim 1, further comprising transmitting, by the at least one blockchain node, a status of the reconfiguration request to the client device.

4. The method of claim 3, wherein the client device comprises a client device of a user that submitted the reconfiguration request.

5. The method of claim 3, wherein the client devices comprises a client device of a user that voted to approve or deny the reconfiguration request.

6. The method of claim 1, further comprising retrying, by the at least one blockchain node, the reconfiguration action when an initial attempt to perform the reconfiguration action fails.

7. The method of claim 6, wherein the reconfiguration action fails due to a duration of the reconfiguration action exceeding a set timeout value.

8. The method of claim 6, further comprising:
receiving, by the at least one blockchain node, a maximum limit on a number of retry attempts that are to be permitted from a user that submitted the reconfiguration request;
prohibiting, by the at least one blockchain node, the retry attempt from being performed when the maximum limit of retry attempts is exceeded; and
allowing, by the at least one blockchain node, the retry attempt to be performed when the maximum limit of retry attempts is not exceeded.

9. The method of claim 1, wherein at least one smart contract executed on the at least one blockchain node performs the triggering and invoking actions, wherein the blockchain service comprises a permissioned blockchain service.

10. An infrastructure governance decision-making system comprising:
at least one blockchain computing device having program instructions stored in memory and executable in the at least one blockchain computing device, when executed by the at least one blockchain computing device, direct the at least one blockchain computing device to:
receive, from a client device, a reconfiguration request for changing infrastructure of a blockchain service by performing a reconfiguration action;
trigger an infrastructure governance approval process to approve or deny the reconfiguration request for changing the infrastructure of the blockchain service; and
invoke initiation of the reconfiguration action by the blockchain service upon approval of the reconfiguration request.

11. The system of claim 10, wherein the reconfiguration action comprises a cryptographic key-exchange action, a pruning action, a software upgrade action, or an action to add or remove one or more blockchain nodes.

12. The system of claim 10, wherein the at least one blockchain computing device is further directed to transmit a status of the reconfiguration request to the client device.

13. The system of claim 12, wherein the client device comprises a client device of a user that submitted the reconfiguration request.

14. The system of claim 12, wherein the client device comprises a client device of a user that voted to approve or deny the reconfiguration request.

15. The system of claim 10, wherein the at least one blockchain computing device is further directed to retry the reconfiguration action when an initial attempt to perform the reconfiguration action fails.

16. The system of claim 15, wherein the reconfiguration action fails due to a duration of the reconfiguration action exceeding a set timeout value.

17. The system of claim 15, wherein the at least one blockchain computing device is further directed to:
receive a maximum limit on a number of retry attempts that are to be permitted from a user that submitted the reconfiguration request;
prohibit the retry attempt from being performed when the maximum limit of retry attempts is exceeded; and
allow the retry attempt to be performed when the maximum limit of retry attempts is not exceeded.

18. The system of claim 10, wherein at least one smart contract executed on the at least one blockchain computing device performs the triggering and invoking actions, wherein the blockchain service comprises a permissioned blockchain service.

19. A non-transitory computer-readable medium for reconfiguring a blockchain infrastructure of permissioned blockchain service comprising program instructions that, when executed by at least one blockchain computing device, direct the at least one blockchain computing device to:
receive, from a client device, a reconfiguration request for changing infrastructure of a blockchain service by performing a reconfiguration action;
trigger an infrastructure governance approval process to approve or deny the reconfiguration request for changing the infrastructure of the blockchain service;
invoke initiation of the reconfiguration action by the blockchain service upon approval of the reconfiguration request;
transmit a status of the reconfiguration request to the client device; and
retry the reconfiguration action when an initial attempt to perform the reconfiguration action fails.

20. The non-transitory computer-readable medium of claim 19, wherein the at least one blockchain computing device is further directed to:
receive a maximum limit on a number of retry attempts that are to be permitted from a user that submitted the reconfiguration request;
prohibit the retry attempt from being performed when the maximum limit of retry attempts is exceeded; and
allow the retry attempt to be performed when the maximum limit of retry attempts is not exceeded.
